(19) United States
(12) Patent Application Publication
(10) Pub. No.: US 2005/0077160 A1
(43) Pub. Date: Apr. 14, 2005

(54) Relay

(75) Inventors: Tetsuya Watanabe, Tokyo (JP); Makoto Noro, Tokyo (JP); Purevdagva Nayanbuu, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/931,980

(22) Filed: Sep. 2, 2004

(30) Foreign Application Priority Data
Oct. 14, 2003 (JP) 2003-353307
Jun. 17, 2004 (JP) 2004-180024

(51) Int. Cl. H01H 29/00

(52) U.S. Cl. 200/182

(57) ABSTRACT

The present invention realizes a highly reliable relay with a longer service life, no moving parts and no insufficient contact, being composed of a fluid path formed on an insulating member, a cell or cells formed at one end or both ends of this fluid path, a plurality of electrodes arranged along the above mentioned fluid path, a gas enclosed in the cell or cells expanding by heating and contracting by cooling, heating or cooling means located in the above cell or cells, and conductive fluid enclosed in the above fluid path; by designing so that at least the above two electrodes are arranged with one end of them in contact with conductive fluid metal enclosed in the above fluid path and one end of them contacts or does not contact with conductive fluid moving in the above fluid path due to the above gas expansion or contraction based on turning ON or OFF of the above heating or cooling means. In addition, cost reduction is intended by forming the fluid path, electrodes and cells using the micro-electromechanical systems (MEMS) technologies and thus manufacturing multiple relay chips at the same time.

### BACKGROUND OF THE INVENTION

1. Field of the Invention

The present invention relates to a relay using an electro-conductive (hereafter abbreviated simply as conductive) fluid (for example, mercury, gallium-indium (GaIn) and gallium-indium-tin (GaInSn)) and also relates to a relay in which obtainment of higher reliability and lower cost is intended.

2. Description of the Prior Art

Contact type relays such as mechanical relays having metal contacts, mercury relays, and reed relays are used for relaying action from the past.

A major problem with relays is the service life of their contacts. Although highly reliable relays with a long service life are being called for in various fields, the current state of affairs is that a definitive relay has not yet appeared. While mercury contact relays have a high degree of reliability, people are reluctant to use them because they are likely to generate environmental pollution problems and they are also expensive. The following documents are prior art in regard to mercury relays and semiconductor relays which will supersede the former:

(Patent Document 1)
Gazette for Japanese Laid-open Patent Application No. 9-61275

(Patent Document 2)
Gazette for Japanese Laid-open Patent Application No. 11-74539

A technique mentioned in Patent Document 1 above relates to equipment for detecting pressure decreases in hydrogen gas enclosed in a mercury relay, and a technique described in Patent Document 2 relates to a semiconductor relay in which the product of the ON-resistance at conduction/cutoff of a contact and the capacitance at cutoff/conduction of a contact is low. This type of relay makes the development of usage at high frequency signals possible by realizing low ON-resistance at low capacitance between output terminals in a low voltage range.

In a mercury relay, contacts are generally enclosed in a sealed glass vessel and are always wetted with mercury put in the vessel to increase the reliability of the contact.

However, the mercury relay is expensive and restricted to limited uses only for the parts where reliability is truly required, while there is a reluctance to use it due to the possibility of a negative effect on the environment when it is disposed of. The present invention aims at achieving high reliability through forming a highly reliable mercury relay using micro-electromechanical systems (MEMS) technologies, as well as offering a relay which decreases the negative influence on the environment by reducing the amount of conductive fluid to be used (for example, mercury, GaIn, or GaInSn).

### SUMMARY OF THE INVENTION

The present invention realizes a highly reliable relay with a longer service life, no moving parts and no insufficient contact, by composing the relay with a fluid path formed on an insulating member, a cell or cells formed at one end or both ends of the fluid path, a plurality of electrodes arranged along the above fluid path, a type of gas which is enclosed in the above cell or cells and expands when heated and contracts when cooled, a heating or cooling means located in the above described cell or cells, and conductive fluid enclosed in the above fluid path.

The present invention also intends to reduce the cost by forming the fluid path, electrodes, and cells using the micro-electromechanical systems (MEMS) technologies, and by manufacturing multiple relay chips at the same time.

### BRIEF DESCRIPTION OF THE DRAWINGS

FIG. 1((a), (b)) is an illustrative configuration drawing indicating an essential part of a relay concerning an embodiment of the present invention.

FIG. 2((a) to (c)) is a drawing illustrating the operation of the relay shown in FIG. 1.

FIG. 3((a) to (c)) is an illustrative configuration drawing indicating an essential part of a relay concerning another embodiment of the present invention.

FIG. 4((a), (b)) is a drawing indicating another embodiment of the present invention.

FIG. 5((a), (b)) is a drawing indicating further another embodiment of the present invention.

FIG. 6((a), (b)) is a drawing indicating furthermore another embodiment of the present invention.

FIG. 7((a) to (d)) is a drawing indicating the essential parts of the manufacturing processes of the relay shown in FIG. 4.

FIG. 8((a), (b)) is a drawing indicating another embodiment of the present invention.

FIG. 9((a) to (e)) is a drawing indicating the essential parts of the manufacturing processes of the relay shown in FIG. 8.

### DESCRIPTION OF THE PREFERRED EMBODIMENT

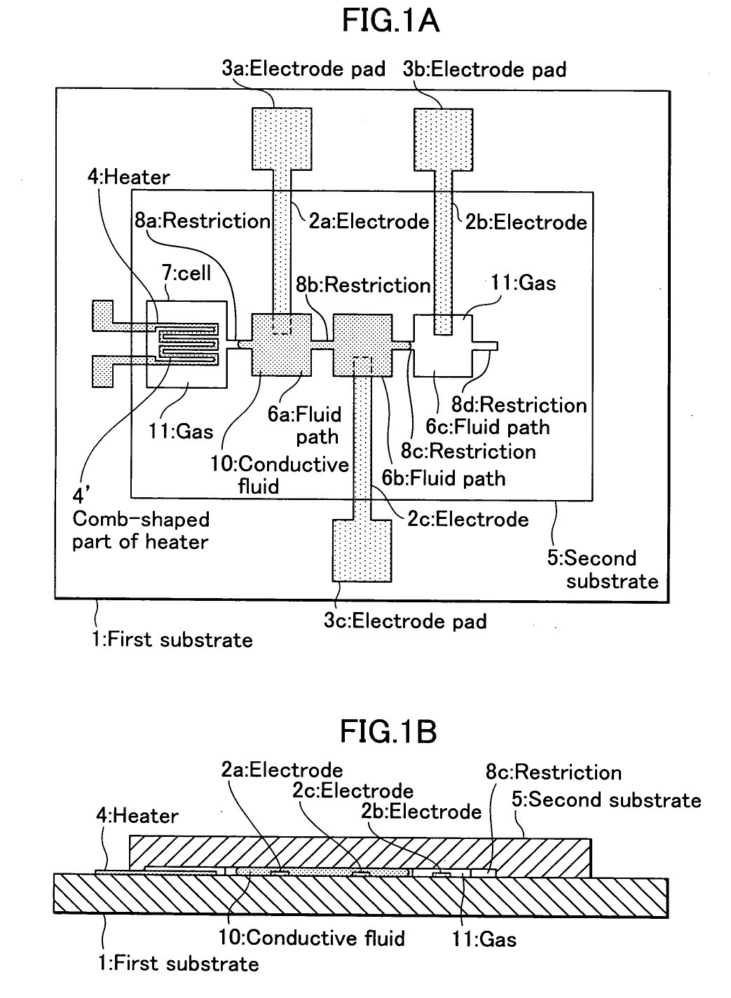

FIG. 1((a), (b)) is an illustrative configuration drawing indicating an essential part of a relay concerning an embodiment of the present invention and FIG. 1(a) is a plan and FIG. 1(b) is a cross-sectional view of the essential part.

In these drawings, first substrate 1 is formed with rectangular glass composed of an insulator. Electrodes 2a and 2b are formed in parallel on substrate 1 away from each other by a predetermined distance and electrode 2c of the same shape as electrode 2a or 2b is formed counter to these electrodes and midway between these two electrodes. These electrodes are formed in a bar respectively and electrode pads 3a, 3b, and 3c are formed at one end of each corresponding electrode. Heater 4, whose middle part is formed in a comb shape (part shown with numeral 4′) is formed on substrate 1.

Second substrate 5 is composed of glass formed in a rectangular shape similar to first substrate 1 and fixed to the surface on which electrodes 2 and heater 4 of substrate 1 are formed by adhesion or the like. On the fixing surface of second substrate 5, fluid path 6 is formed and cell 7 communicating with fluid path 6 is formed at one end of the fluid path. In addition, restrictions 8a to 8d are formed at a predetermined interval in fluid path 6. In this embodiment, the restrictions are formed to give a state in which fluid path 6 is partitioned to three small cells of 6a, 6b, and 6c.

In a relay shown in FIG. 1, the surface of first substrate 1 on which electrodes 2 and heater 4 are formed, and the surface of second substrate 5 on which fluid path 6 and cell 7 are formed, are shown counter to each other in an air-tight state by adhering them using an adhesive or the like.

In addition, second substrate 5 is formed smaller than first substrate 1 in this embodiment to an extent of electrode pad portions (3a, 3b, and 3c) and the pad portions at both ends of heater 4 formed on first substrate 1 projecting from second substrate 5 in an adhered state.

In this embodiment, the tip of electrode 2a is positioned in partitioned fluid path 6a, the tip of electrode 2b is positioned in partitioned fluid path 6c, and the tip of electrode 2c is positioned in partitioned fluid 6b so that it is counter to electrodes 2a and 2b. Comb-shaped part 4′ of heater 4 is hermetically sealed in cell 7 formed by adhesion of the first substrate 1 and the second substrate.

Fluid path 6 is filled with conductive fluid 10, for example, mercury, and cell 7 is filled with gas 11, for example, air or nitrogen gas. In the normal state, conductive fluid (mercury) 10 is located in partitioned fluid paths 6a and 6b and is stable in the position shown in the drawing because of the surface tension of mercury and restrictions 8a and 8c. In this state, contact electrode 2a is conductive with contact electrode 2c.

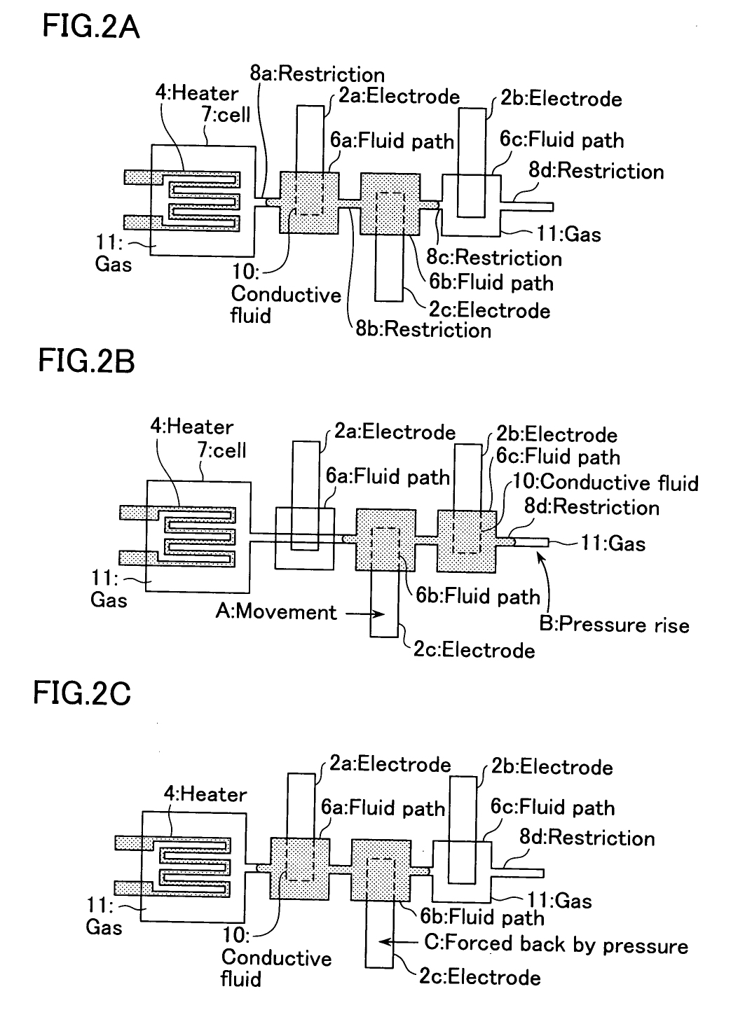

FIG. 2((a), (b), and (c)) is a drawing illustrating the operation of the relay in the above mentioned configuration.

In the initial state as shown in FIG. 2(a), conduction between electrodes 2a and 2c is ON and that between electrodes 2c and 2b is OFF. When current is passed through heater 4 in cell 7, gas 11 (air, nitrogen gas, or the like) in cell 7 expands due to the heat generated by heater 4.

As a result, conductive fluid (mercury) 10 moves to fluid path 6c as shown with an arrow A and so conduction between electrodes 2a and 2c becomes OFF and that between electrodes 2c and 2b becomes ON. In this case, gas 11 in fluid path 6c moves into restriction 8d and the pressure of the portion shown with B rises.

Next, when current through heater 4 in cell 7 is cut off, expanded gas 11 contracts and together with gas contraction, conductive fluid (mercury) 10 is forced back towards fluid paths 6a and 6b returning to the initial state as shown in FIG. 2(c) by the pressure in restriction 8d.

According to such a configuration, normally open and normally closed type relays can be realized by selecting the state of connecting leads to electrodes.

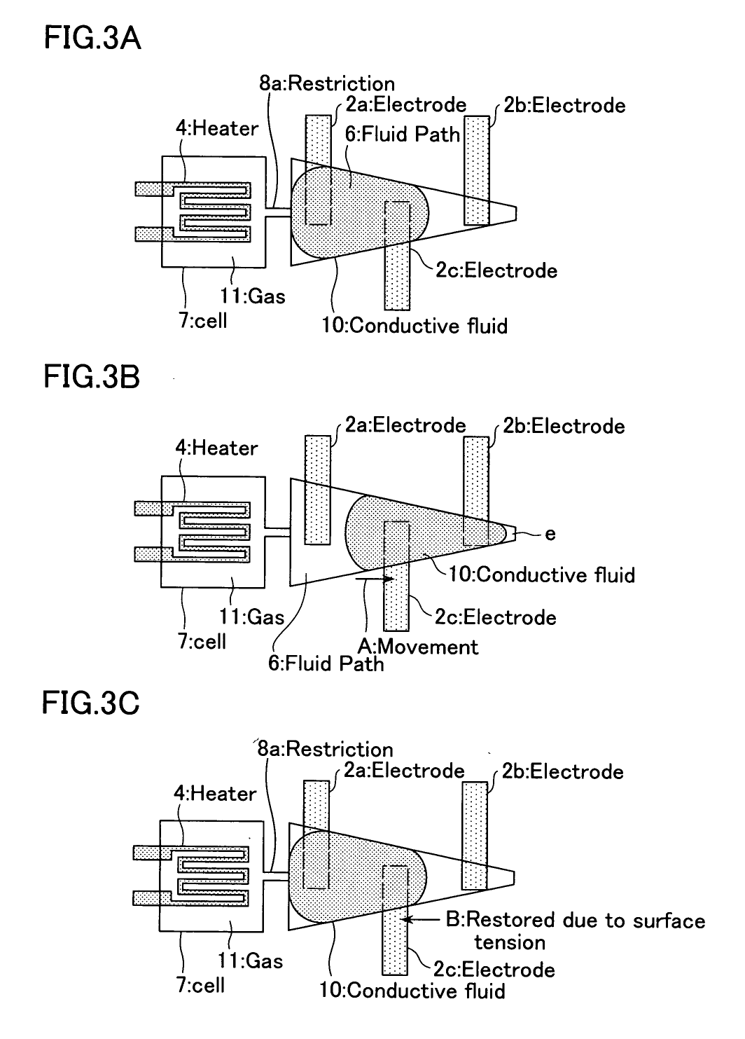

FIG. 3((a), (b), and (c)) shows another embodiment of normally open and normally closed type relays. However, since the configuration is the same as the embodiment shown in FIG. 2 except for fluid paths, the same signs are given to the same elements and the duplicated description will be omitted. In this embodiment, a fluid path is formed so that one side composing a fluid path is shorter than the other sides, that is, into an isosceles triangle-like shape, and cell 7 and approximate middle part of the shorter side are connected by restriction 8a.

In the initial state as shown in FIG. 3(a), conduction between electrodes 2a and 2c is ON and that between electrodes 2c and 2b is OFF. When current is passed through heater 4 in cell 7, gas 11 (air, nitrogen gas, or the like) in cell 7 expands due to the heat generated by heater 4.

As the result, conductive fluid (mercury) 10 moves towards the direction of arrow A as shown in FIG. 3(b) and so conduction between electrodes 2a and 2c becomes OFF and that between electrodes 2c and 2b becomes ON. In this state, the gas pressure of the apex-like portion e of the isosceles triangle rises.

Next, when current through heater 4 in cell 7 is cut off, expanded gas 11 contracts and together with gas contraction, a gas pressure in fluid path 6 becomes the normal pressure, and conductive fluid (mercury) 10 is forced back returning to the initial state as shown in FIG. 3(c) due to the surface tension of conductive fluid 10.

Using such a configuration, normally open or normally closed type relays can also be realized by selecting an electrode connection state. In this configuration, since there is no restriction, restoration to the initial state becomes faster and so a relay having a faster changeover speed than that mentioned in the embodiment shown in FIG. 1 can be achieved.

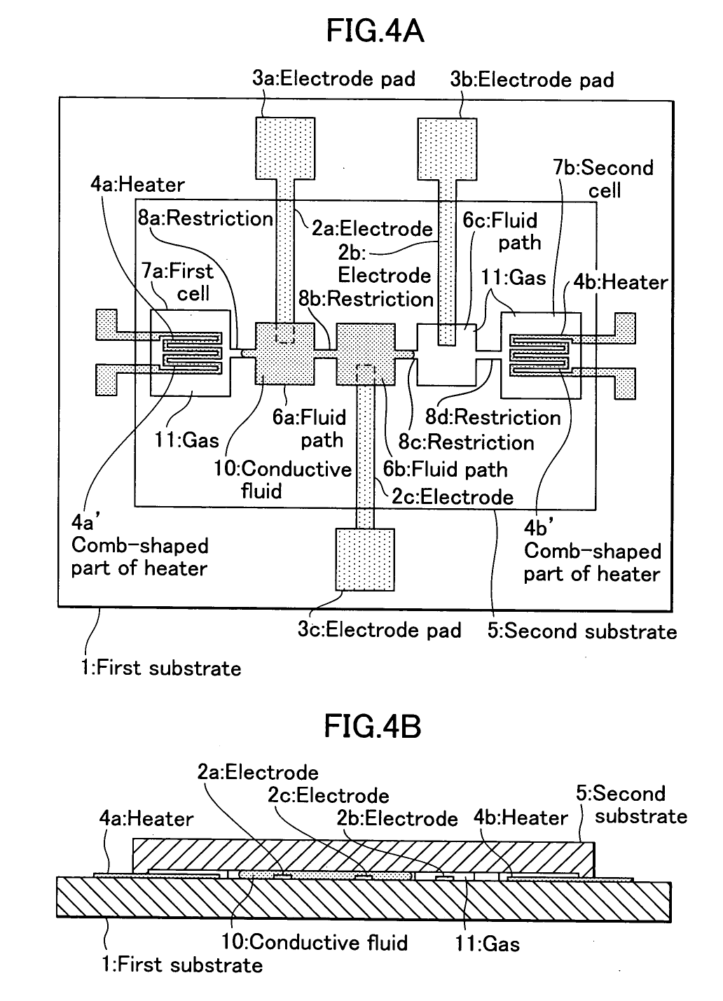

FIG. 4((a), (b)) shows another embodiment and FIG. 4(a) is the plan and FIG. 4(b) is the cross-sectional view.

This embodiment differs from that shown in FIG. 1 only in the point in which the cell provided at one end of fluid path 6 is numbered 7a as first cell and a heater is numbered 4a and second cell 7b and heater 4b are provided at the other end of fluid path 6. Accordingly, in this embodiment, conduction between electrodes 2a and 2c is ON and conduction between electrodes 2b and 2c is OFF by conductive fluid (mercury) 10 in the normal state.

Next, when current is passed through heater 4a positioned in first cell 7a, the gas in first cell 7a expands due to the heat generated by heater 4a. As a result, conductive fluid 10 moves towards second cell 7b and so conduction between electrodes 2a and 2c becomes OFF and that between electrodes 2c and 2b becomes ON.

In addition, electrodes 2a to 2c and heaters 4a and 4b on first substrate 1 and fluid path 6(a, b, c) and cells 7a and 7b on second substrate 5 are formed by photolithography and etching using the micro-electromechanical systems (MEMS) technologies. The above described relay can be realized within a 2 to 3 mm square.

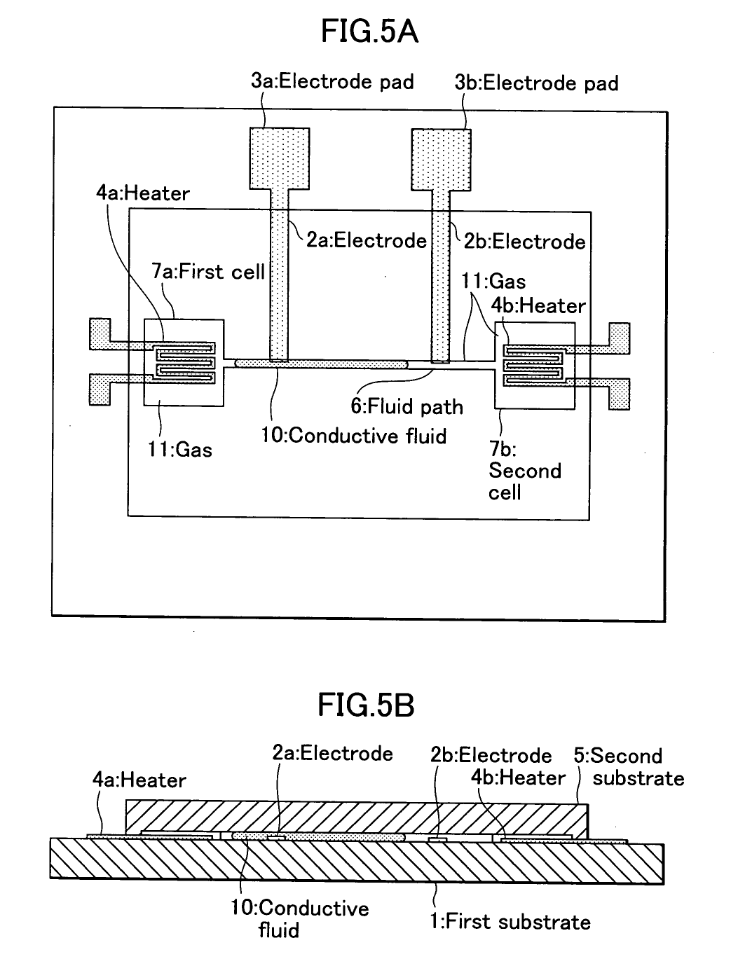

FIG. 5((a), (b)) shows further another embodiment of the present invention and FIG. 5(a) is the plan and FIG. 5(b) is the cross-sectional view.

This embodiment differs from that shown in FIG. 4 only in the shape of fluid path and the number of electrodes.

In this embodiment, first cell 7a and second cell 7b are formed airtight at both ends of a single fluid path 6 without restriction, and electrodes 2a and 2b formed distant by a predetermined interval from each other are arranged so that the tips of them are positioned to contact with conductive fluid (mercury) 10 sealed in fluid path 6. Further, gas 11 is enclosed in first cell 7a and second cell 7b similar to the state shown in FIG. 4.

In the above mentioned configuration, the tips of electrodes 2a and 2b contact with sealed conductive fluid 10 and so conduction between electrodes 2a and 2b is ON (indication in the drawing is omitted) in the relay's normal state. If gas 11 expands by the current passed through heater 4b, in, for example, second cell 7b, conductive fluid 10 moves towards first cell 7a. As the result, conduction between electrodes 2a and 2b becomes OFF.

Similarly, if gas 11 expands by the current passed through heater 4a in first cell 7a, conductive fluid 10 moves toward second cell 7b. As a result, conduction between electrodes 2a and 2b changes from an OFF state to an ON state. In this embodiment, electrodes 2a and 2b, heaters 4a and 4b on first substrate 1 and fluid path 6 and first and second cells 7a and 7b on second substrate 5 are also formed by photolithography and etching using the micro-electromechanical systems (MEMS) technologies.

In addition, although description is made in the above embodiments that one relay is formed on one substrate, micro-electromechanical systems (MEMS) technologies enable multiple relays to be formed on one substrate at the same time. This results in cost reduction.

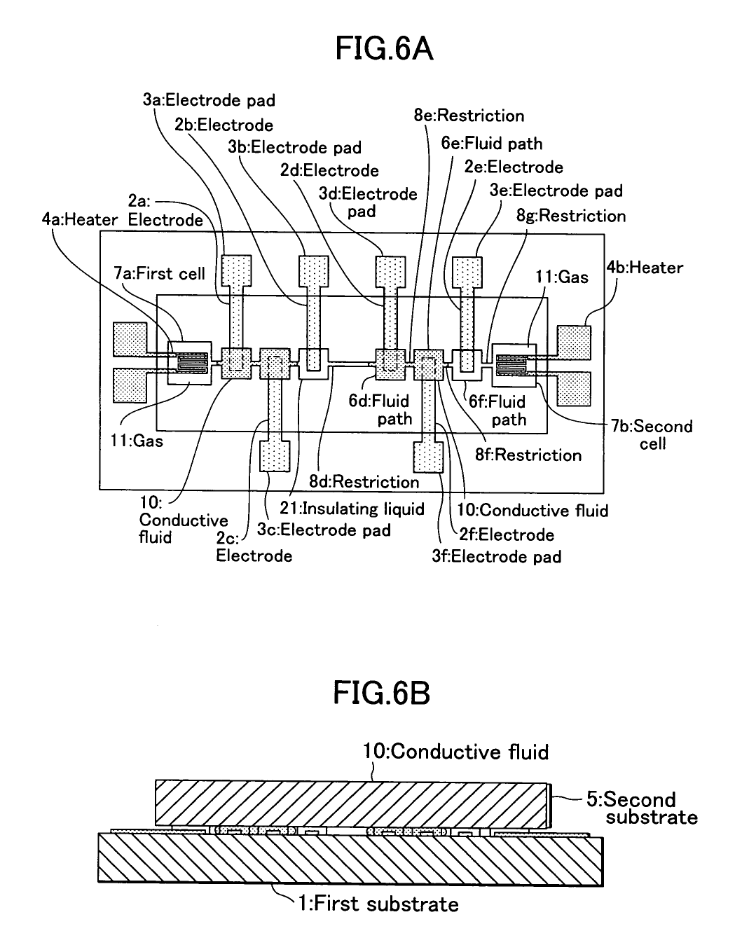

FIG. 6((a), (b)) shows an embodiment in which two linking relays are formed on one substrate and FIG. 6(a) shows the plan and FIG. 6(b) shows the cross-sectional view.

In this embodiment, partitioned fluid paths 6d, 6e and 6f and restrictions 8e, 8f and 8g are formed by extending the fluid path shown in FIG. 4, and heater 4b is arranged in second cell 7b provided at the extended end of the fluid path. In this configuration, independent relays are constructed by enclosing insulating liquid (for example, silicone oil) 21 in the place of restriction 8d linking the two relays.

In FIG. 6, conduction between electrodes 2a and 2c and conduction between 2d and 2f are ON in a normal state. When current is passed through heater 4a in first cell 7a, gas 11 expands and conduction fluid 10 on both sides of insulating liquid 21 enclosed in restriction 8d moves towards heater 4b. Thus conduction between electrodes 2b and 2c and conduction between electrodes 2e and 2f become ON while conduction between electrodes 2a and 2c and conduction between electrodes 2d and 2f become OFF.

Next, when the current through heater 4a is cut off and another current is passed through heater 4b in second cell 7b, gas 11 in cell 7b expands and conductive fluid on both sides of insulating liquid 21 enclosed in restriction 8d moves towards heater 4a, and conduction between electrodes 2a and 2c and conduction between electrodes 2d and 2f become ON while conduction between electrodes 2b and 2c and conduction between electrodes 2e and 2f become OFF.

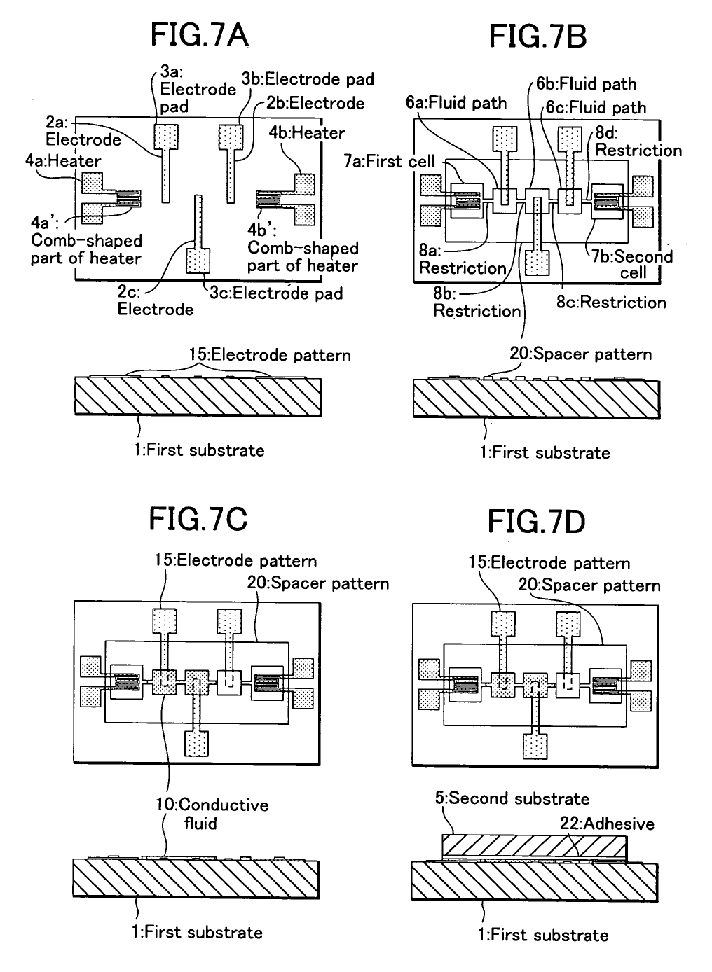

FIG. 7((a) to (d)) shows plans and cross-sectional views indicating an example of manufacturing processes for the relay shown in FIG. 4. Description is given to each process in turn.

In process (a), heater 4 and electrodes 2a to 2c including electrode pads 3a to 3c are formed on first substrate 1 as patterns.

In process (b), the patterns for the heater and electrodes are coated with photoresist or the like and spacer pattern 20 is formed, where fluid paths 6 including restrictions 8 and cells 7 are to be formed.

In process (c), conductive fluid 10 is injected into fluid path 6 including restriction 8.

When making the injection, a kind of conductive fluid of the desired volume is dropped into a predetermined space controlling its pressure using a glass capillary, for example, a commercially available one having approximately an outer diameter of 0.5 mm and an inner diameter of 0.01 mm, and a microscope.

In process (d), the second substrate is fixed using a kind of adhesive.

Further, the material of the first and second substrates should be glass, one of the insulators. However, if a substrate is insulated from the outside using insulating film, a conductive substrate may also be employed.

Furthermore, gold, molybdenum, chrome and so on, can be used as materials for electrodes and heaters. They should be selected corresponding to the type of conductive fluid and/or gas to be enclosed. The material for spacers is not limited to photoresist if it is insulating and enables patterns to be formed, but it may be, for example, low-melting point glass. Adhesive is not required for low-melting point glass because low-melting point glass has an adhering function in itself. In addition, even conductive members may also be used as spacers if they can be insulated from electrodes using insulating film.

Although typical conductive fluid is mercury, conductive fluids such as GaIn and GaInSn or the like can also be used. For GaIn and GaInSn, their surfaces are easily oxidized and if the surfaces are oxidized, portions other than metal electrode surfaces, for example, glass surfaces become wetted. In this case, current cannot be cut off. As a countermeasure, the adhering process for the second substrate which functions as a lid is carried out in a reducing atmosphere (for example hydrogen or ammonia) or in an inert gas atmosphere (for example nitrogen or argon). As a result, these gases can be enclosed in fluid paths and thus oxidation of conductive fluids can be prevented. Further, if a relay is used at an elevated temperature for the whole relay, solder can be used as a conductive fluid.

In the meantime, there is a classified group of “high frequency relay” in general relays, which can be used up to about 40 GHz. In order to operate a relay at high frequency (not the speed of ON and OFF but at the frequency of the signal to be turned ON and OFF), impedance matching is important because if matching is not taken, the signal is reflected at the mismatching point and becomes attenuated.

In relays shown in the aforementioned FIGS. 1 and 4, impedance matching is not considered at all and their operating limit is a few MHz.

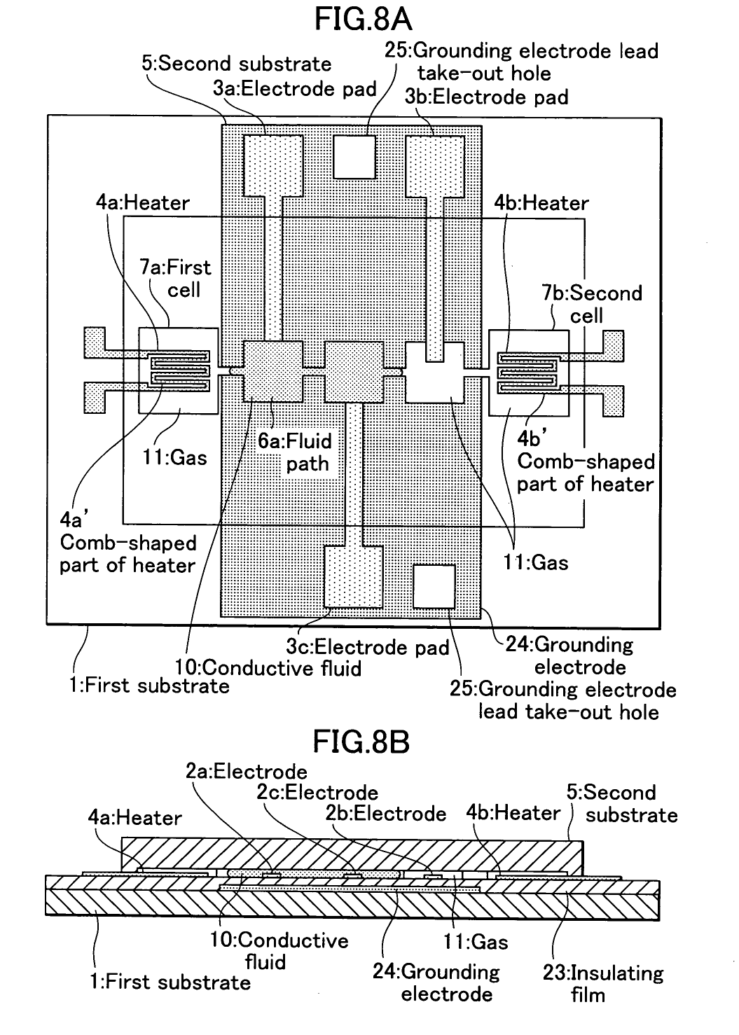

FIG. 8((a), (b)) shows a relay in which high frequency operation is made possible by considering impedance matching for the relay shown in FIG. 4. FIG. 8(a) is the plan and FIG. 8(b) is the cross-sectional view.

In FIG. 8, the same signs are given to the same elements as shown in FIG. 4. Grounding electrode 24 is formed under electrodes 2 intervening insulating film 23 and grounding electrode lead take-out hole 25 is formed by removing a part of insulating film 23.

According to such a configuration, the capacitance between electrodes 2a, 2b, and 2c and grounding electrode 24 and the electrode lead inductance determine the characteristic impedance, and the high frequency characteristic of the relay can be improved by making this characteristic impedance, an impedance of wiring before the signal is input to the relay, and an impedance of wiring after the signal is output from the relay all agree with the same value (for example, 50Ω).

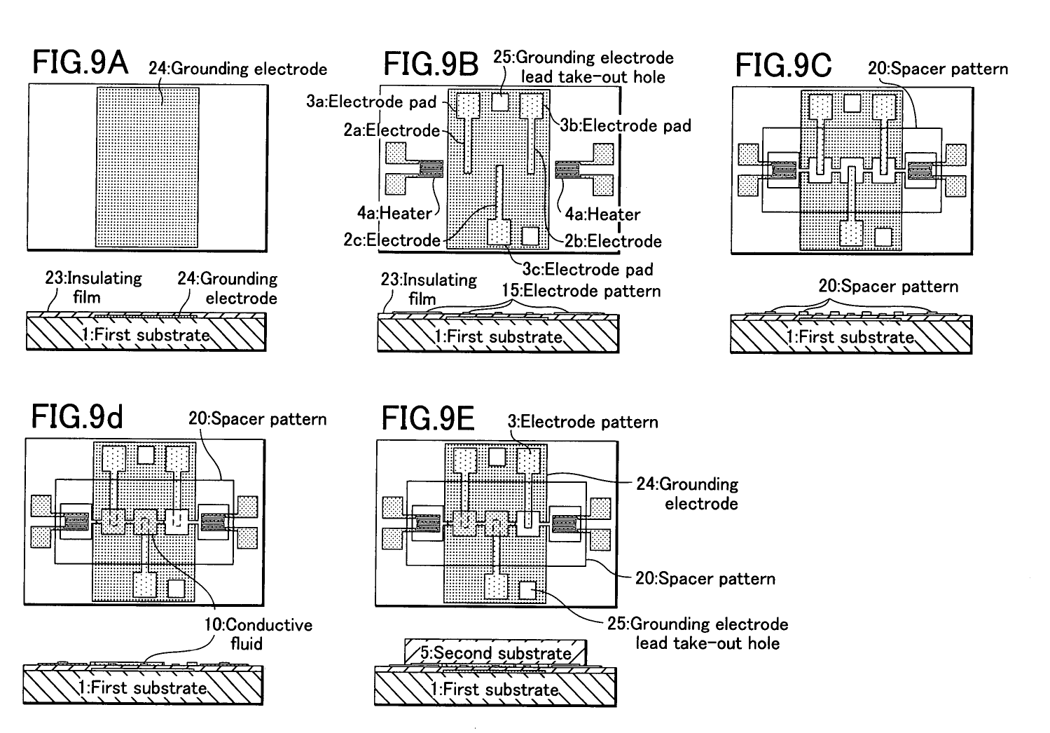

FIG. 9(a) to (e) show plans and cross-sectional views of the manufacturing processes for the relay shown in FIG. 8. The procedure is described according to the processes.

In process (a), grounding electrode 24 having a prescribed area is formed in a place where electrodes 2a to 2c including electrode pads 3a to 3c are formed on first substrate 1, and insulating film 23 is formed covering grounding electrode 24.

In process (b), patterns for heater 4 and electrodes 2a to 2c including electrode pads 3a to 3c are formed on insulating film 23, and grounding electrode lead take-out holes 25 are formed by removing parts of insulating film 23.

In process (c), the patterns for the heater and electrodes are coated with photoresist or the like and spacer pattern 20 is formed, where fluid paths 6 including restrictions 8 and cells 7 are to be formed.

In process (d), conductive fluid 10 is injected into fluid paths 6 including restrictions 8.

When making the injection, a kind of conductive fluid of the desired volume is dropped into a predetermined space controlling its pressure using a glass capillary, for example, a commercially available one having approximately an outer diameter of 0.5 mm and an inner diameter of 0.01 mm, and a microscope, similar to the ones described above.

In process (e), second substrate 5 is fixed using a kind of adhesive.

As described above, according to the present invention, the following effects are given:
(1) Since the relay of the present invention has no moving parts and causes no insufficient contacts to occur, highly reliable and long service life relays can be realized.
(2) Cost reduction can be intended because multiple relay chips can be manufactured at the same time using a substrate.
(3) Relays for higher frequency signals can be achieved by matching impedances devising electrode patterns and preparing a grounding electrode under the electrodes including fluid paths intervening insulating film.
(4) Miniaturization is enabled because manufacturing is done using micro-electromechanical systems (MEMS) technologies. Since the volume of fluid paths can be made small and enclosed mercury can be reduced to, for example, about 1×10⁻⁶ g, negative influence on the environment can be decreased.

In addition, the above description is simply giving a mere specific preferred embodiment for the purpose of instruction and illustration of the present invention. For instance, although the conductive fluid is illustrated as mercury in the above embodiment, another conductive fluid (for example GaIn or GaInSn) may be used if it has a similar function, and the gas may be one other than air or nitrogen (for example, hydrogen, argon, or ammonia). Further, the shape of the fluid path, the shape of the electrode and the shape of the heater cell are also not restricted to those shown in the drawings.

Furthermore, although glass is used for substrates in the above description, other members (for example, one obtained by forming oxide film or nitride film on the surface of a silicon substrate) can be employed if the substrate has an insulating property and makes photolithography and etching possible. The shape of the substrate is also not restricted to a rectangular one.

Although the gas is expanded using a heater in the above embodiment, conductive fluid may also be moved by contracting the gas using a cooling means (for example, Peltier element or the like).

Accordingly, the present invention is not restricted to the above embodiment but may be embodied in other specific forms, changes, and versions without departing from the true spirit thereof.

1. A relay composed of a fluid path formed on an insulating member, a cell formed at one end of this fluid path, a plurality of electrodes arranged along said fluid path, a gas which is enclosed in said cell and expands when heated and contracts when cooled, a heating or cooling means located in said cell, and conductive fluid enclosed in said fluid path.

2. A relay in accordance with claim 1, wherein said fluid path is formed in a triangular shape and communicating with said cell via a restriction.

3. A relay composed of a fluid path formed on an insulating member, a plurality of electrodes arranged in this fluid path distant by a predetermined interval from adjacent electrodes, first and second cells located at both ends of said fluid path respectively communicating with said fluid path, a gas and a heating or cooling means enclosed in the first and second cells, and conductive fluid enclosed in said fluid path.

4. A relay in accordance with claim 1 or claim 3, wherein said plurality of electrodes is arranged with one end of them in contact with conductive fluid enclosed in said fluid path and designed so that one end of them contacts or does not contact with conductive fluid moving in said fluid path due to said gas expansion or contraction based on turning ON or OFF of said heating or cooling means.

5. A relay in accordance with claim 1 or claim 3, wherein at least two of said electrodes located in said fluid path are paired and such pairs are isolated by insulating liquid.

6. A relay in accordance with claim 1 or claim 3, wherein portions of said fluid path where said electrodes contact the conductive fluid are made so that their volumes are large and other portions of said fluid function as restrictions because their volumes are small.

7. A relay in accordance with claim 1 or claim 3, wherein a grounding electrode is provided intervening insulating film under said electrodes including said fluid path.

8. A relay in accordance with claim 1 or claim 3, wherein said fluid path, electrodes and cells are formed using the micro-electromechanical systems (MEMS) technologies.

9. A relay in accordance with claim 1 or claim 3, wherein said conductive fluid includes any of mercury, GaIn, or GaInSn and said gas includes any of air, nitrogen, argon, hydrogen, or ammonia.
